(19) United States
(12) Patent Application Publication
(10) Pub. No.: US 2026/0184311 A1
(43) Pub. Date: Jul. 2, 2026

(54) METHOD FOR OPERATING A VEHICLE

(71) Applicants: Mercedes-Benz Group AG, Stuttgart (DE); Robert Bosch GmbH, Stuttgart (DE)

(72) Inventors: Sebastian STROBACH, Holzgerlingen (DE); Abel ECKART, Leingarten (DE)

(21) Appl. No.: 19/129,953

(22) PCT Filed: Nov. 20, 2023
(86) PCT No.: PCT/EP2023/082391

§ 371 Date: May 14, 2025

(30) Foreign Application Priority Data
Dec. 14, 2022 (DE) 10 2022 133 293.4

(51) Int. Cl. B60W 30/18; B60W 10/08; B60W 10/18

(52) U.S. Cl. CPC B60W 30/18127; B60W 10/08; B60W 10/18; B60W 2510/081; B60W 2520/28; B60W 2540/10; B60W 2540/12; B60W 2710/083; B60W 2710/18

(57) ABSTRACT

A method for operating a vehicle where the vehicle may have at least one electric machine which can be operated in an engine mode for driving the vehicle and in a generator mode for recuperative braking of the vehicle. The vehicle may also have an energy storage unit and/or energy sink which supplies the at least one electrical machine with electrical energy during engine operation and is charged by means of electrical energy recuperated during generator operation of the at least one electrical machine and/or further enables recuperative braking. The vehicle may also have a recuperation braking system for carrying out the recuperative braking, the system may be the at least one electric machine and the energy storage unit and/or energy sink. The vehicle may also have a friction braking system with a friction braking device being a wheel braking actuator.

The invention relates to a method for operating a vehicle according to the features of the generic term of claim 1.

A method for controlling a brake recuperation device of a mild hybrid motor vehicle is known from the prior art, as described in DE 10 2016 007 838A1. For braking, the motor vehicle has a brake control system with at least one hydraulic friction brake as the first brake actuator and at least one electric machine as the second brake actuator. The electric machine can be operated as a generator to recuperate kinetic energy from the motor vehicle. The recuperated energy is charged into an energy storage device. The first and second brake actuators are not capable of blinding, at least when the driver brakes. In a first step of the method, a target wheel torque characteristic curve for providing a predeterminable target wheel torque to a drive train of the motor vehicle, which comprises the electric machine, is specified as a function of an instantaneous brake pedal travel. The target wheel torque characteristic is then varied as a function of braking processes that were carried out before a current braking process.

DE 10 2016 201 937 A1 describes a method for determining the initial slope of a braking torque-slip characteristic curve from a measured braking slip of at least one vehicle wheel of a vehicle and a recuperative braking torque on this vehicle wheel. In the method, the wheel speed of the braked vehicle wheel is measured and the wheel speed of the braked vehicle wheel is determined from the wheel speed. Furthermore, the wheel speed of an unbraked vehicle wheel of the vehicle is measured and the vehicle speed is determined from the wheel speed. The brake slip is determined from the wheel speed of the braked vehicle wheel and the vehicle speed. Furthermore, the recuperative braking torque is determined by measuring the electrical power generated by recuperation. The initial slope of the braking torque-slip characteristic is determined from the recuperative braking torque and the determined slip.

DE 10 2012 222 507 A1 discloses a method for operating a recuperation brake of a motor vehicle. First of all, a future operating intensity of the recuperation brake for a preceding route of the motor vehicle is estimated using an input which characterizes the driving style of the preceding route. Furthermore, a maximum slip-free vehicle braking power for the route is estimated depending on the input. In addition, the braking power of the recuperation brake is set to a target braking power that is not greater than the maximum vehicle braking power for the route. Finally, the recuperation brake is applied with the target braking power on the route ahead.

DE 10 2012 210 046 A1 describes a method for controlling a braking system of a motor vehicle. The motor vehicle can be braked by means of a friction brake and an electric machine that can be operated as a generator. During a braking process, a friction braking torque to be applied by the friction brake and a recuperation torque to be applied by the electric machine are reduced during a braking torque reduction phase until a corrected total braking torque to be applied by the friction brake and the electric machine is reached. The recuperation torque to be applied by the electric motor is influenced by a first feedback loop with compensation within a second feedback loop for controlling the electric motor.

DE 10 2010 054 620 A1 discloses a method for determining the braking torque of a vehicle with a traction battery, at least one recuperative brake and at least one friction brake on a drive axle, taking into account a lateral dynamic driving state of the vehicle. In the method, at least one braking requirement is determined and the total braking torque for the vehicle is determined. A first braking torque and a second braking torque of the drive axle are determined from the total braking torque of the vehicle. Furthermore, a lateral dynamic driving state of the vehicle is determined. A third braking torque of the drive axle is determined as a function of the first and second braking torques and the transverse dynamic driving state. Furthermore, a fourth braking torque of the drive axle is determined by the at least one recuperative brake and/or the traction battery. In addition, a fifth braking torque of the drive axle is determined by limiting the third braking torque of the drive axle by the fourth braking torque of the drive axle. The total braking torque of the vehicle is divided into a braking torque for the at least one recuperative brake of the drive axle and a braking torque for the at least one friction brake of the drive axle.

The invention is based on the task of providing an improved method of operating a vehicle compared to the prior art.

The problem is solved according to the invention by a method for operating a vehicle with the features of claim 1.

Advantageous embodiments of the invention are the subject of the subclaims.

A vehicle comprises at least one electrical machine which can be operated in an engine mode for driving the vehicle and in a generator mode for recuperative braking of the vehicle, and an energy storage unit and/or energy sink which supplies the at least one electrical machine with electrical energy during engine operation and is charged by means of electrical energy recuperated during generator operation of the at least one electrical machine and/or further enables recuperative braking. The energy storage unit can also comprise an energy sink, in particular with regard to the recuperated electrical energy, or be designed as such an energy sink or vice versa, or a combination of energy storage unit and energy sink, in particular with regard to the recuperated electrical energy, can be provided. It can then also be provided, for example, that the recuperated energy is not or not completely stored. This energy storage unit and/or energy sink comprises, for example, at least one traction battery and/or at least one capacitor, in particular a supercapacitor, and/or at least one flywheel mass storage device and/or at least one resistor, in particular a large resistor, or is designed as one of these components. In particular, if the energy sink only comprises the resistor, the recuperative energy is therefore not stored but converted into thermal energy. However, when the resistor is used, it is advantageously provided only in addition to another of the components mentioned. As a result, recuperated electrical energy can be stored and, furthermore, if this is not possible due to a full state of charge or other circumstances, for example, recuperative braking can continue by converting the remaining recuperated electrical energy in the resistor into heat.

The vehicle further comprises a recuperation braking system for performing recuperative braking, comprising the at least one electric machine and the energy storage unit and/or energy sink. The vehicle further comprises a friction braking system with a friction braking device comprising a wheel braking actuator.

The friction brake system is, for example, a hydraulic brake system, but can also be designed as a different friction brake system. If the friction brake system is a hydraulic brake system, then the friction brake device is accordingly a hydraulic brake device, a friction brake actuator mentioned in the following is then a hydraulic brake actuator, the friction braking mentioned in the following is then hydraulic braking, a friction braking force distribution specification mentioned in the following is then a hydraulic braking force distribution specification, a controlled friction deceleration torque mentioned in the following is then a controlled hydraulic deceleration torque and a friction target braking torque mentioned in the following is then a hydraulic target braking torque.

In a method for operating this vehicle, it is provided according to the invention that a request signal for a deceleration torque generated by an accelerator pedal of the vehicle and/or by at least one assistance function of the vehicle is processed in a control unit not belonging to the friction brake system, whereby it is checked whether a current state of the recuperation brake system permits recuperative braking. The control unit not belonging to the friction brake system is in particular a central control unit, in particular a central control unit of a, in particular electric, drive train of the vehicle, which in particular comprises the at least one electric machine and the energy storage unit and/or energy sink.

The current state of the recuperation braking system is in particular a current state of availability of the recuperation braking system, i.e. in particular of the electric braking system formed by the electric drive train of the vehicle. The current state of the recuperation braking system is, in particular, a current state of charge of the energy storage unit or relates to this current state of charge of the energy storage unit. It is therefore checked in particular whether the energy storage unit can still be charged by the recuperative braking, and if so, how much energy generated by the recuperative braking it can still absorb, or whether it is already fully charged. The vehicle is then braked recuperatively in accordance with the requested deceleration torque, either completely or to the extent that the current state of the recuperation braking system, in particular the energy storage unit, permits recuperative braking.

Furthermore, it is provided in particular that if the current state of the recuperation braking system, in particular of the energy storage unit, does not permit recuperative braking in accordance with the requested deceleration torque or does not permit it completely, a remaining portion of the requested deceleration torque which cannot be achieved by recuperative braking is forwarded to a brake control system of the friction brake system and the vehicle is accelerated in accordance with this remaining portion of the requested deceleration torque by means of the friction brake system, which cannot be achieved by recuperative braking, is forwarded to a brake control system of the friction brake system and the vehicle is braked in accordance with this remaining portion of the requested deceleration torque by means of the friction brake system, in particular by means of its friction brake device.

Assistance functions that can generate a request signal for a deceleration torque are, for example, predictive cruise control, which adapts the speed of the vehicle to a road ahead, for example, and/or distance control to a vehicle in front and/or an automated, highly automated or autonomous driving function of the vehicle.

In particular, the solution according to the invention shifts functional scopes of a wheel stabilization during recuperative braking to a control unit, in particular a drivetrain control unit, of the electric drivetrain As a result of the solution according to the invention, essential functional scopes of the recuperative vehicle braking, in particular with regard to deceleration torque requirements from the accelerator pedal and from one or more assistance systems, are thus outsourced from the hydraulic brake system, in particular from its brake control system and also from a vehicle dynamics control system, and combined directly in this control unit that is not part of the hydraulic brake system, in particular in the central control unit, and processed there, whereby recuperative braking is primarily used and only any remaining deceleration torque is realized by the friction brake system.

The solution according to the invention avoids signal loops in particular. Previously, all deceleration torque requests from the accelerator pedal and from one or more assistance systems, which were initially recorded in the control unit not belonging to the friction brake system, were transmitted by this control unit to the friction brake system, in particular to its brake control system and/or to the vehicle dynamics control system previously assigned to the friction brake system. From there, a respective proportion of the requested deceleration torque, which was to be generated by recuperative braking, was then transmitted back to this control unit, which was not part of the friction brake system. This created a recuperation signal loop. By avoiding this recuperation signal loop, the functions relating to recuperative braking in particular can run faster and better.

In a possible embodiment of the method, it is also provided that a request signal for a deceleration torque generated by a brake pedal of the vehicle is processed in the brake control system of the friction brake system. This checks whether the current state of the recuperation braking system, in particular the energy storage unit, permits recuperative braking. The requested deceleration torque is forwarded to the control unit that is not part of the friction brake system to the extent that the current state of the recuperation brake system, in particular the energy storage unit, permits recuperative braking, and the vehicle is braked recuperatively accordingly. The vehicle is braked by means of the friction brake system, in particular by means of its friction brake device, in accordance with a remaining proportion of the requested deceleration torque. This means that recuperative braking also has priority over friction braking. However, if the deceleration torque is requested by the brake pedal, it is intended that the brake control system checks whether recuperation is possible or not. This also has the advantage of short signal propagation times, as the brake pedal is coupled to the brake control system and therefore its request signal would first have to be forwarded to the control unit that is not part of the friction brake system, in particular the central control unit, for evaluation. This is avoided in the present solution, so that friction braking can also take place very quickly, as the signal processing relating to friction braking takes place entirely in the brake control system, i.e. the control unit not belonging to the friction brake system, in particular the central control unit, is not responsible for this. In this respect, longer signal propagation times are also avoided.

The solution described here therefore retains the existing architecture of signal detection and forwarding, i.e. request signals from the accelerator pedal and assistance functions were also previously detected by the control unit not belonging to the friction brake system, in particular the central control unit, and the request signal from the brake pedal was also previously detected by the brake control system. This will continue to be the case. The processing of the request signal from the brake pedal in the brake control system is also retained in order to avoid longer signal paths. The previous transmission of the request signals from the accelerator pedal and assistance functions to the brake control system, which led to the signal loop described above, has been changed and is now avoided.

In particular, it is provided that the current state of the recuperation brake system, in particular the energy storage unit, is determined by the control unit not belonging to the friction brake system and is forwarded to the brake control system. This ensures that this current state of the recuperation brake system, in particular the energy storage unit, is available both in the control unit belonging to the friction brake system and in the brake control system and can be used in the manner described above.

In an alternative embodiment, the deceleration requests of the brake pedal are also processed in the manner described above for the deceleration requests of the accelerator pedal and the assistance functions, i.e. in particular also primarily in the control unit not belonging to the friction brake system, in particular the central control unit. This means that the request signal for a deceleration torque generated by the vehicle's brake pedal is also processed in the control unit that is not part of the friction brake system, whereby it is checked whether the current state of the recuperation brake system, in particular the energy storage unit, permits recuperative braking. The vehicle is then braked recuperatively in accordance with the requested deceleration torque, either completely or to the extent that the current state of the recuperation braking system, in particular the energy storage unit, permits recuperative braking. In this alternative embodiment, it is then also provided in particular that, if the current state of the recuperation braking system, in particular the energy storage unit, does not permit recuperative braking in accordance with the requested deceleration torque, or does not permit it completely, a remaining portion of the requested deceleration torque that is not generated by the recuperation braking system is braked, which cannot be achieved by recuperative braking, is forwarded to the brake control system of the friction brake system and the vehicle is braked in accordance with this remaining portion of the requested deceleration torque by means of the friction brake system, in particular by means of its friction brake device.

In particular, it is provided that the deceleration torque for recuperative braking is forwarded by the control unit not belonging to the friction brake system as an electrical target braking torque to a drivetrain control unit of the vehicle's electric drivetrain comprising the at least one electric machine.

In addition, it is provided in particular that a driving dynamics control unit transmits a minimum drive speed for the electric machine to the powertrain control unit and the powertrain control unit performs recuperative braking by controlling the at least one electric machine in accordance with the electrical target braking torque, but only until the minimum drive speed is reached. When the minimum drive speed is reached, the recuperative braking, i.e. a recuperation torque, is thus reduced in order to maintain the specified minimum drive speed. When the minimum drive speed is reached, the powertrain control unit transmits a remaining deceleration torque to the vehicle dynamics control system, which cannot be achieved by recuperative braking.

In particular, it is provided that the deceleration torque for friction braking is transmitted from the brake control system to the friction braking device as a friction target braking torque.

In addition, it is provided in particular that the vehicle dynamics control transmits a minimum wheel speed to the friction braking device and the friction braking device performs the friction braking by activating a friction braking actuator in accordance with the friction target braking torque, but only until the minimum wheel speed is reached.

When the minimum wheel speed is reached, the friction braking, i.e. a friction braking torque, is thus reduced in order to maintain the specified minimum wheel speed. When the minimum wheel speed is reached, the friction braking device transmits a remaining deceleration torque to the vehicle dynamics control system, which cannot be achieved by friction braking.

In one possible embodiment, it is provided that the vehicle dynamics control system for stabilizing the vehicle transmits a settable electrical deceleration torque to the control unit not belonging to the friction brake system, in particular the central control unit, and/or the brake control system of the friction brake system, i.e. a deceleration torque that can be set off recuperatively by at least one electric machine at the corresponding time.

Advantageously, this is taken into account accordingly during recuperative braking and/or friction braking, i.e. the vehicle is braked and/or friction-braked accordingly. The electrical deceleration torque that can be applied is, in particular, a maximum possible electrical torque that can be applied. If a deceleration request, for example due to a slippery road surface or other circumstances, in particular those detected by the vehicle dynamics control system, cannot be fully reduced by recuperative braking, only the portion that can be reduced recuperatively is transmitted. This is the electrical deceleration torque that can be dissipated, i.e. the deceleration torque that can be dissipated recuperatively by at least one electrical machine at the corresponding time. The brake control system or the control unit that is not part of the friction brake system, in particular the central control unit, thus knows that additional requests via the brake pedal, accelerator pedal or assistance functions can no longer be made electrically, but must be made via the friction brake.

In one possible embodiment, the vehicle dynamics control system transmits a brake force distribution specification to the control unit not belonging to the friction brake system, in particular the central control unit, and/or the brake control system of the friction brake system.

The driving dynamics control is, for example, outsourced from the friction brake system, in particular an independent unit, for example an independent control unit. It is therefore not integrated into the control unit, in particular the central control unit, which is not part of the friction brake system.

The specification of the minimum drive speed by the vehicle dynamics control enables targeted brake slip control with the vehicle's electric drive train on the basis of this dynamic driving limit specification of the vehicle dynamics control, so that recuperative braking is possible up to this limit. The minimum drive speed includes, for example, a specified maximum wheel slip of, say, three percent, which must not be exceeded, as otherwise there would be a risk of driving instability. Previously, recuperation was switched off when slip occurred. With the solution described here, however, the recuperation torque, i.e. the deceleration torque generated by the recuperative braking, is only reduced when the specified minimum drive speed is reached or undershot, and this recuperation torque is built up again when the specified minimum drive speed is left or exceeded.

Previously, negative torques of the electric drivetrain were monitored in the vehicle dynamics control system and reduced if necessary. This meant that every braking request, i.e. every request signal for a deceleration torque, always had to pass through the vehicle dynamics control system, resulting in the recuperation signal loop described above.

In the method described here, deceleration torques are monitored directly in the powertrain control unit and reduced if necessary. In particular, an electric braking request, i.e. a recuperation braking request, is limited directly in the powertrain control unit so that the vehicle is no longer destabilized. Using the method described, braking requests, i.e. deceleration torque requests, can therefore be made directly by different requesters, for example from the accelerator pedal, from a longitudinal control assistance function and from the brake pedal. The vehicle dynamics control merely specifies the minimum drive speed for the electric drive train, i.e. for the at least one electric machine, and the minimum wheel speed for the friction brake system in order not to exceed a maximum slip. The electric torques, in particular recuperation torques, are monitored by the electric drivetrain, in particular its drivetrain control unit, and no longer by the vehicle dynamics control system. The friction brake torque is monitored by the friction brake system.

In particular, the solution described enables an increase in the availability of recuperation. Recuperation, i.e. recuperative braking, is always fully possible on the part of the vehicle dynamics control until the specified minimum drive speed threshold is reached. In particular, the procedure described avoids destabilization of the vehicle due to negative torques.

As already mentioned, recuperation was previously stopped completely when slip occurred. This was realized by setting a slip bit. In the method described here, this slip bit and therefore the hard switch-off of recuperation when a predefined slip threshold is exceeded is no longer necessary. This is made possible by the targeted protection against destabilization of the vehicle by specifying and maintaining the minimum drive speed threshold, so that recuperation can continue to take place up to this minimum drive threshold. This means that recuperative braking only has to be reduced in order not to fall below the minimum drive speed, but not switched off completely.

The method described also makes it possible to increase vehicle stability in the dynamic driving limit range, as the method described enables targeted slip control to improve vehicle stability.

In addition, the process increases recuperation efficiency, particularly in so-called one-pedal driving, i.e. when the vehicle is driven using only the accelerator pedal, whereby the vehicle is decelerated by recuperative braking as the accelerator pedal is increasingly released, as well as during assistance function braking. If the vehicle is only braked by recuperative braking, there is also no volume displacement of brake fluid into a low-pressure reservoir and no application of brake pads to brake discs.

In particular, the method is based on a previously used signal world, but time-critical signals in the form of torque specifications are replaced by inertial signals, namely by a respective speed specification in the form of vehicle speed minus brake slip. This is achieved by the described monitoring using the minimum wheel speed specified by the vehicle dynamics control or the minimum drive speed specified by the vehicle dynamics control. In addition, the method described here distributes the control to the control units that can implement the control specification most quickly. In the drivetrain control unit, for example, the deceleration torque specifications are converted into the drive speed values in a cycle of one millisecond, whereas previously the torque was calculated in the driving dynamics control unit in 20 ms cycles and then had to be sent to the control units via a network.

Previously, the latency was present within the control loop due to the transmission time of the target torque via the network of the control loop vehicle dynamics control-central control unit-powertrain control unit. In the method described here, the latency is outside the control loop, which enables higher dynamics in the control loop. The control loop is now closed in the powertrain control unit.

In the procedure described here, two coordinators are used for braking requests, the control unit not belonging to the friction brake system, in particular the central control unit for recuperative braking and the brake control system for friction braking. Previously, everything was coordinated together in the vehicle dynamics control system, resulting in the aforementioned recuperation signal loop.

In the method described here, each braking actuator, i.e. both the electric drive train and the friction braking device, has its own actuator-related control, which is based in particular not only on torques, but also on torques and predetermined minimum speeds, i.e. on the minimum drive speed or the minimum wheel speed.

In the method described here, brake pedal requests, i.e. deceleration torques requested via the brake pedal, can also be made electrically in the manner described above, i.e. can also lead to recuperative braking, and accelerator pedal requests, i.e. deceleration torques requested via the accelerator pedal, can also be made via the friction brake system, i.e. can also lead to friction braking.

This is made possible by the two coordinators mentioned above, which exchange or coordinate the respective delay requests with each other and can request them from the respective partner control unit via the interface as required.

The method described here enables recuperative braking even when slip occurs, as the stability of the vehicle is ensured by the specified minimum drive speed.

The method described makes it possible to fulfill both tasks of a recuperation function, i.e. ensuring stability by distributing to the actuators of the friction brake system and the electric drivetrain and maintaining and distributing a respective deceleration torque requirement.

In the method described, non-latency-critical signals in the form of speed specifications are used instead of latency-critical signals in the form of torque specifications. A speed specification is not latency-critical, as it is an inertial variable that matches the current vehicle speed. A torque specification is latency-critical, as it has to perform a high torque stroke quickly and, in the previous procedure, is also sent from the vehicle dynamics control system via the central control unit to the powertrain control unit, with associated latency times on a bus and in the control units.

In the method described here, the control unit that is not part of the friction brake system, in particular the central control unit, commands the desired deceleration torque directly to the powertrain control unit. Up to now, recuperation torque specifications from the central control unit have always been routed via the vehicle dynamics control and then forwarded to the powertrain control unit. Recuperation torque reductions are now carried out directly on the powertrain control unit, based on the deceleration torque specification of the control unit that is not part of the friction brake system, in particular the central control unit, and the minimum drive speed specified by the vehicle dynamics control. Previously, the reduction of the recuperation torque took place in the vehicle dynamics control system and was then forwarded to the powertrain control unit via the central control unit.

The solution described enables OnePedalDriving to be extended to the entire available recuperation range. Recuperation levels can be set flexibly. Fast torque settings analogous to the accelerator pedal movement are possible, as the friction brake system is not activated, i.e. no electric brake booster of the friction brake system has to be moved, for example. This also avoids corresponding noises, which could have a disturbing effect. The process enables a direct response behavior of the electric drivetrain without unnecessary latency formation and filtering.

The process increases the availability of recuperative braking. It also enables recuperative braking up to the dynamic driving limits. For example, the process also enables recuperative braking when cornering with high lateral acceleration and after dynamic braking control system interventions where recuperation was previously switched off. The process thus enables recuperative braking even with low road friction values up to the dynamic driving limits.

The process also enables an increase in vehicle stability during recuperative braking.

Recuperative braking is always possible to the full extent within the dynamic driving limits, in particular within a specified wheel slip. If the specified wheel slip is exceeded, recuperative braking in the powertrain control unit is reduced by the deceleration torque required to reduce the wheel slip back below the specified slip threshold.

The process enables an improvement in efficiency, as it is possible to brake without a friction brake, in particular without using the OneBox (brake pedal and vehicle dynamics control in one component) and without a decoupled brake system for OnePedalDriving and assistance functions. When decelerating with OnePedal and assistance functions, there is no residual brake pressure in the system and no friction brake is applied, as no hydraulic volume needs to be shifted.

The NVH problem (noise, vibration, harshness), i.e. the noise and vibration problem of the brake system, is improved, as the friction brake system only has to be activated when the friction brake is used.

As already mentioned, the method minimizes latencies, since time-critical signals in the form of the torque specification are replaced by slow signals, i.e. by the speed specification in the form of vehicle speed minus brake slip, the signals are sent directly without delays due to looping and waiting for feedback signals, and the control is distributed to the control units that can implement the control specification most quickly, as already described above.

The method allows the longitudinal controller interface to be simplified, as the drive torque interface is used for the electric braking part of the longitudinal controller, so that the same interface is used for drive mode and recuperative braking mode. In addition, a separate recuperation function is no longer required for the longitudinal controller.

Examples of embodiments of the invention are explained in more detail below with reference to a drawing.

This shows:

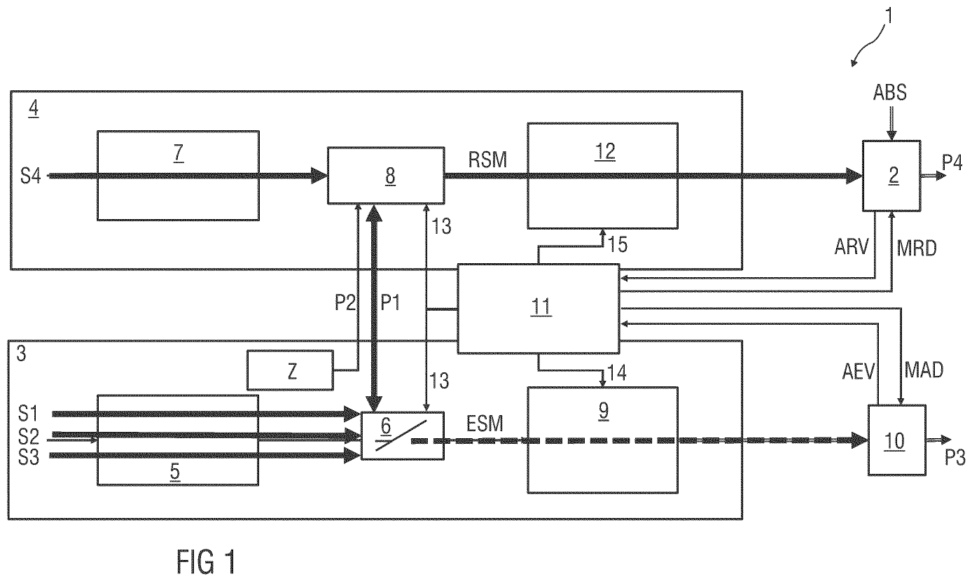

FIG. 1 A schematic representation of a vehicle.

FIG. 1 shows a schematic representation of a recuperative braking torque coordination system with stability protection of a vehicle 1, whereby for reasons of clarity only components of a friction brake system and a recuperative brake system of the vehicle 1 are shown here.

The vehicle 1 has at least one electric machine which can be operated in an engine mode to drive the vehicle 1 and in a generator mode for recuperative braking of the vehicle 1.

Furthermore, the vehicle 1 has an energy storage unit or energy sink which supplies the at least one electric machine with electrical energy during engine operation and is charged by means of electrical energy recuperated during generator operation of the at least one electric machine or enables further recuperative deceleration. The vehicle 1 also has the recuperation braking system for performing recuperative braking, which comprises the at least one electric machine and the energy storage unit and/or energy sink. The vehicle 1 also has the friction braking system with a friction braking device 2, which comprises a wheel brake actuator.

In a method for operating this vehicle 1, it is provided that a request signal S1, S2, S3 for a deceleration torque generated by an accelerator pedal of the vehicle 1 and/or by at least one assistance function of the vehicle 1 is processed in a control unit 3, hereinafter referred to as central control unit 3, which is not part of the friction brake system. First, a setpoint 5 for manual or assisted driving is formed from the request signal S1, S2, S3. The system then checks whether a current state Z of the recuperation braking system, in particular a charge state of the energy storage unit, permits recuperative braking, i.e. in particular whether the energy storage unit has sufficient electrical potential to absorb the recuperated energy. The vehicle 1 is then braked recuperatively according to the requested deceleration torque completely or to the extent to which the current state Z of the recuperation braking system, in particular the energy storage unit, permits recuperative braking.

If the current state Z of the recuperation braking system, in particular the energy storage unit, does not permit recuperative braking in accordance with the requested deceleration torque, or does not permit it completely, a remaining portion of the requested deceleration torque which cannot be achieved by recuperative braking is forwarded to a brake control system 4 of the friction brake system, as shown by arrow P1, and the vehicle 1 is accelerated in accordance with this remaining portion of the requested deceleration torque, which cannot be achieved by recuperative braking, is forwarded to a brake control system 4 of the friction brake system, as shown by arrow P1, and the vehicle 1 is braked in accordance with this remaining portion of the requested deceleration torque by means of the friction brake system, in particular by means of its friction brake device 2. This check and, if necessary, the distribution 6 of the requested deceleration torque is thus carried out in the central control unit 3.

A request signal S4 for a deceleration torque generated by a brake pedal of the vehicle 1 is processed in the brake control system 4 of the friction brake system. First, a setpoint 7 for manual braking is formed from the request signal S4. The system then checks whether the current state Z of the recuperation braking system, in particular the energy storage unit, permits recuperative braking. For this purpose, the current state Z of the recuperation braking system, in particular the energy storage unit, is determined by the central control unit 3 and forwarded to the brake control system 4, as shown by an arrow P2.

Furthermore, this determined state Z of the recuperation brake system, in particular the energy storage unit, is also used in the central control unit 3 in the manner described above.

The requested deceleration torque is forwarded to the central control unit 3 to the extent that the current state Z of the recuperation braking system, in particular the energy storage unit, permits recuperative braking, as shown by the arrow P1 in the form of a double arrow. The vehicle 1 is braked recuperatively accordingly. Vehicle 1 is friction-braked according to a remaining portion of the requested deceleration torque. This check and distribution 8 of the requested deceleration torque thus takes place in the brake control system 4.

The portion of the requested deceleration torque for recuperative braking is first subjected to torque processing 9 in the central control unit 3 as an electric setpoint braking torque ESM, which includes torque shaping and, if necessary, torque distribution for efficiency and driving dynamics reasons. The torque shaping serves to ensure a gradient of the deceleration so that the full deceleration is not implemented abruptly. The torque distribution from the point of view of efficiency and driving dynamics takes place when the vehicle 1 has several electric machines, in particular an electric machine on a front axle and another electric machine on a rear axle. In this case, the electric target braking torque ESM can be distributed to these electric machines, whereby this is done in particular in such a way that recuperation is achieved as efficiently as possible and/or adapted to the driving dynamics.

The deceleration torque for the recuperative braking, in this case the electrical target braking torque ESM processed in this way, is then forwarded by the central control unit 3 to a drivetrain control unit 10 of the electric drivetrain of the vehicle 1 comprising the at least one electric machine or the multiple electric machines. This is then transmitted to the respective electric machine, as shown schematically by an output arrow P3, and this is operated accordingly.

In order to ensure driving stability of the vehicle 1 even during recuperative braking, in particular to avoid excessive slippage, it is provided that a driving dynamics control unit 11 transmits a minimum drive speed MAD for the electric machine or the respective electric machine to the powertrain control unit 10 and the powertrain control unit 10 performs recuperative braking by controlling the at least one or respective electric machine in accordance with the electrical setpoint braking torque ESM, but only until the minimum drive speed MAD is reached. When the minimum drive speed MAD is reached, the powertrain control unit 10 transmits a remaining, i.e. regulated, electrical deceleration torque AEV to the vehicle dynamics control 11, which cannot be achieved by recuperative braking. The resulting maximum settable electrical torque is communicated to the central control unit 3 and the brake control system 4 by the vehicle dynamics control 11 as the settable electrical deceleration torque 13.

The portion of the requested deceleration torque for friction braking is first subjected to torque processing 12 in the brake control system 4 as a friction target braking torque RSM, which includes torque distribution from stability aspects, i.e. in particular a distribution to the front axle and rear axle of the vehicle 1.

The deceleration torque for friction braking, in this case the friction target braking torque RSM processed in this way, is then forwarded to the friction braking device 2 by the brake control system 4. This is then transmitted to a friction brake actuator, as shown schematically by an output arrow P4, and this is operated accordingly. The friction brake device 2 also receives information from an anti-lock braking system ABS of the vehicle 1. In order to ensure the driving stability of the vehicle 1 even during friction braking, in particular to avoid excessive slippage, it is provided that the vehicle dynamics control 11 transmits a minimum wheel speed MRD to the friction braking device 2 and the friction braking device 2 performs friction braking by activating the friction brake actuators in accordance with the friction target braking torque RSM, but only until the minimum wheel speed MRD is reached. When the minimum wheel speed MRD is reached, the friction brake device 2 transmits a remaining, i.e. regulated, friction deceleration torque ARV to the vehicle dynamics control 11, which cannot be achieved by friction braking.

To stabilize the vehicle 1, the vehicle dynamics control system 11 transmits the deceleration torque 13 to the central control unit 3 and the brake control system 4 of the friction brake system, which can be released recuperatively by at least one electric machine at the corresponding time. This deceleration torque flows into the respective distribution 6, 8 of the requested deceleration torque and is thus taken into account, whereby the vehicle 1 is braked recuperatively and/or friction-braked accordingly.

In the example shown, the vehicle dynamics control 11 also transmits an electrical brake force distribution specification 14 or friction brake force distribution specification 15 to the central control unit 3 and the brake control system 4 of the friction brake system. In the example shown, the electrical brake force distribution specification 14 is taken into account in the torque processing 9 in the central control unit 3. In the example shown, the friction brake force distribution specification 15 is taken into account in the torque processing 12 in the brake control system 4.

### LIST OF REFERENCES

1 Vehicle
2 Friction brake device
3 Control unit/central control unit not part of the friction brake system
4 Brake control system
5 Setpoint formation for manual or assisted driving
6 Distribution of the requested deceleration torque in the central control unit
7 Setpoint generation for manual braking
8 Distribution of the requested deceleration torque in the brake control system
9 Torque processing in the central control unit
10 Powertrain control unit
11 Driving dynamics control
12 Torque processing in the brake control system
13 electrical deceleration torque that can be deducted
14 Electrical brake force distribution specification
15 Friction brake force distribution specification
ABS Anti-lock braking system
AEV Reduced electrical deceleration torque
ARV Reduced friction deceleration torque
ESM Electrical set braking torque
RSM Frictional braking torque
MAD Minimum drive speed
MRD Minimum wheel speed
P1 Arrow
P2 Arrow
P3 Output arrow
P4 Output arrow
S1 Request signal generated by gas pedal pedal
S2 Request signal generated by assistance function
   Request signal generated by assistance function
S4 Request signal generated by brake pedal
Z Current status of the recuperation brake system

1-10. (canceled)

11. A method for operating a vehicle, the vehicle having
at least one electric machine which can be operated in an engine mode for driving the vehicle and in a generator mode for recuperative braking of the vehicle,
an energy storage unit and/or energy sink which supplies the at least one electrical machine with electrical energy during engine operation and is charged by means of electrical energy recuperated during generator operation of the at least one electrical machine and/or further enables recuperative braking,
a recuperation braking system for carrying out the recuperative braking, comprising the at least one electric machine and the energy storage unit and/or energy sink, and
a friction brake system with a friction brake device comprising a wheel brake actuator,
characterized in that a request signal for a deceleration torque generated by an accelerator pedal of the vehicle and/or by at least one assistance function of the vehicle is processed in a control unit not belonging to the friction brake system, wherein it is checked whether a current state of the recuperation braking system permits recuperative braking, and the vehicle is braked recuperatively in accordance with the requested deceleration torque completely or to the extent to which the current state of the recuperation braking system permits recuperative braking.

12. The method according to claim 11, characterized in that, if the current state of the recuperation braking system does not permit or does not completely permit recuperative braking in accordance with the requested deceleration torque, a remaining portion of the requested deceleration torque, which cannot be achieved by recuperative braking, is forwarded to a brake control system of the friction braking system and the vehicle is braked in accordance with this remaining portion of the requested deceleration torque by means of the friction braking system.

13. The method according to claim 12, characterized in that a request signal for a deceleration torque generated by a brake pedal of the vehicle is processed in the brake control system of the friction brake system, wherein it is checked whether the current state of the recuperation brake system permits recuperative braking, and
the requested deceleration torque is forwarded to the control unit not belonging to the friction brake system to the extent to which the current state of the recuperation brake system permits recuperative braking, and the vehicle is braked recuperatively accordingly, and
the vehicle is braked by means of the friction brake system in accordance with a remaining portion of the requested deceleration torque.

14. The method according to claim 13, characterized in that the current state of the recuperation brake system is determined by the control unit, which is not part of the friction brake system, and is forwarded to the brake control system.

15. The method according to claim 11, characterized in that the deceleration torque for the recuperative braking is forwarded by the control unit not belonging to the friction brake system as an electric setpoint braking torque to a powertrain control unit of an electric powertrain of the vehicle comprising the at least one electric machine.

16. The method according to claim 15, characterized in that a driving dynamics control unit transmits a minimum drive speed for the electric machine to the drive train control unit and the drive train control unit carries out the recuperative braking by activating the at least one electric machine in accordance with the electrical setpoint braking torque, but only until the minimum drive speed is reached, the powertrain control unit transmitting a remaining deceleration torque, which cannot be achieved by recuperative braking, to the vehicle dynamics control unit when the minimum drive speed is reached.

17. The method according to claim 12, characterized in that the deceleration torque for the friction braking is transmitted from the brake control system to the friction braking device as a friction target braking torque.

18. The method according to claim 17, characterized in that the vehicle dynamics control transmits a minimum wheel speed to the friction brake device and the friction brake device carries out the friction braking by actuating a friction brake actuator in accordance with the friction target braking torque, but only until the minimum wheel speed is reached, wherein the friction brake device transmits a remaining deceleration torque, which cannot be achieved by friction braking, to the vehicle dynamics control when the minimum wheel speed is reached.

19. The method according to claim 16, characterized in that the vehicle dynamics control for stabilizing the vehicle transmits a settable electrical deceleration torque to the control unit not belonging to the friction brake system and/or to the brake control system of the friction brake system and the vehicle is braked recuperatively and/or friction-braked accordingly.

20. The method according to claim 16, characterized in that the vehicle dynamics control transmits a braking force distribution specification to the control unit not belonging to the friction brake system and/or to the brake control system of the friction brake system.
